(19) United States
(12) Patent Application Publication
(10) Pub. No.: US 2025/0247686 A1
(43) Pub. Date: Jul. 31, 2025

(54) Returning Attachment of a Communication Device to a Home Wireless Communication Network Based on Geo-location

(71) Applicant: T-Mobile Innovations LLC, Overland Park, KS (US)

(72) Inventors: Kyeong Hun An, Sammamish, WA (US); Amit Shantanu Deshmukh, Sammamish, WA (US); Mathew George, Kirkland, WA (US); Kulandaivel Marappa Gounder, Bothell, WA (US); Nilesh Ranjan, Sammamish, WA (US)

(21) Appl. No.: 18/427,710

(22) Filed: Jan. 30, 2024

(51) Int. Cl. H04W 8/08; H04W 36/30; H04W 36/32

(52) U.S. Cl. CPC H04W 8/08; H04W 36/304; H04W 36/322

(57) ABSTRACT

A quality of experience QoE server associated with a home wireless communication service network. The QoE server comprises a QoE application that, when executed by the QoE server, receives an indication of a location of a user equipment (UE), wherein the UE is subscribed to receive wireless communication service with the home network and that the UE is in a roaming operation mode, searches a geo-location database using the indication of the location of the UE, based on searching the geo-location database, determines that the home network or a preferred network is located proximate to the indication of the location of the UE, and sends a request to the UE to perform a refresh operation, wherein the UE initiates a scan of cell site frequencies, detects a cell site associated with the home network or the preferred network, and attaches wirelessly to the cell site.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

User equipment (UE) in the form of wireless communication devices are capable of roaming between different networks provisioned by different network providers. For example, a user may subscribe or otherwise contractually obtain (such users being referred to herein as “subscribed users”) access for their UE to a first or home network provisioned by a first or home network provider. In addition to obtaining access for the UE to the home network, the user may also obtain access for the UE to additional networks provisioned by other network providers without needing to subscribe to these additional networks. Instead, the user may freely and automatically roam (e.g., automatically obtain access for the UE) to these additional networks via prearranged agreements made between the home network provider and the other network providers provisioning these additional networks whereby the user may enjoy uninterrupted connectivity of their UE even in locations in which it is not possible to access the home network (e.g., locations out of range of each functional access point of the home network).

### SUMMARY

In an embodiment, a quality of experience server computer associated with a home wireless communication service network is disclosed. The quality of experience server computer comprises a processor; a non-transitory memory, wherein the non-transitory memory stores a geo-location database that associates geo-locations to a home network or to a preferred network; and a quality of experience application stored in the non-transitory memory. When executed by the processor, the quality of experience application sends a request to a first subscriber identity module (SIM) applet of a first user equipment (UE) for a current location of the first UE, wherein the first UE is subscribed to receive wireless communication service with the home wireless communication service network, receives an indication of the location of the first UE from the first SIM applet, wherein the first UE is in a roaming operation mode, and searches the geo-location database using the indication of the location of the first UE. Based on searching the geo-location database, the quality of experience application further determines that the home network is located proximate to the indication of the location of the first UE, sends a request to the first SIM applet to perform a refresh operation, wherein the UE initiates a scan of cell site frequencies, detects the first cell site associated with the home network, and attaches wirelessly to the first cell site, receives a feedback message from the first SIM applet reporting the successful rehoming of the first UE to the home network via the first cell site and at the indicated location of the first UE, and updates the geo-location database with the information about the successful rehoming of the first UE to the home network, wherein the geo-location database is progressively adapted based on feedback information received from the first UE.

In another embodiment, a method of managing roaming activity of a user equipment (UE) is disclosed. The method comprises sending a request by a quality of experience (QoE) application executing on a computer system to a subscriber identity module (SIM) applet of a first user equipment (UE) for a current location of the first UE and receiving a message by the QoE application, wherein the message comprises an indication of the location of the first UE and an indication that the first UE is attached to a roaming network. The method further comprises searching a database by the QoE application based on the indication of the location of the first UE; and based on finding a preferred network in the database that is associated with the indication of the location of the first UE, sending a short message service (SMS) message to the SIM applet commanding the SIM applet to send a refresh request to a main processor of the first UE, wherein the first UE is prompted to rescan available cell site frequencies, to detach from the roaming network, and to attach to the preferred network.

In yet another embodiment, a quality of experience server computer associated with a home wireless communication service network is disclosed. The quality of experience server comprises a processor; a non-transitory memory, wherein the non-transitory memory stores a geo-location database that associates geo-locations to a home network or to a preferred network; and a quality of experience application stored in the non-transitory memory. When executed by the processor, the quality of experience application receives an indication of a location of a user equipment (UE), wherein the UE is subscribed to receive wireless communication service with the home wireless communication service network and the UE is in a roaming operation mode and searches the geo-location database using the indication of the location of the UE. Based on searching the geo-location database, the quality of experience application determines that the home network or a preferred network is located proximate to the indication of the location of the UE and sends a request to the UE to perform a refresh operation, wherein the UE initiates a scan of cell site frequencies, detects a cell site associated with the home network or the preferred network, and attaches wirelessly to the cell site.

In yet another embodiment, a method of managing roaming activity of a user equipment (UE) is disclosed. The method comprises sending a request by a quality of experience (QoE) application executing on a computer system to a first subscriber identity module (SIM) applet of a first user equipment (UE) for a current location of the first UE, wherein the first UE is subscribed to receive wireless communication service with the home wireless communication service network and receiving an indication of the location of the first UE by the QoE application from the first SIM applet, wherein the first UE is in a roaming operation mode. The method further comprises searching a geo-location database by the QoE application using the indication of the location of the first UE, wherein the geo-location database associates geo-locations to a home network or to a preferred network and, based on searching the geo-location database, determining by the QoE application that the home network is located proximate to the indication of the location of the first UE. The method further comprises sending a request by the QoE application to the first SIM applet to perform a refresh operation, wherein the first UE initiates a scan of cell site frequencies, detects a first cell site associated with the home network, and attaches wirelessly to the first cell site; receiving a feedback message by the QoE application from the first SIM applet reporting the successful rehoming of the first UE to the home network via the first cell site and at the indicated location of the first UE; and updating the geo-location database by the QoE application with the information about the successful rehoming of the first UE to the home network, wherein the geo-location database is progressively adapted based on feedback information received from the first UE.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2 is a flow chart of a method according to an embodiment of the disclosure.

FIG. 3 is an illustration of a wireless communication device according to an embodiment of the disclosure.

FIG. 4 is a block diagram of a hardware architecture of a wireless communication device according to an embodiment of the disclosure.

FIG. 5A and FIG. 5B are block diagrams of a communication network according to an embodiment of the disclosure.

FIG. 6A is a block diagram of a first software architecture of a wireless communication device according to an embodiment of the disclosure.

FIG. 6B is a block diagram of a second software architecture of a wireless communication device according to another embodiment of the disclosure.

FIG. 7 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

When a wireless communication device (user equipment-UE) is receiving wireless communication while roaming in a network that is different from the home network (e.g., the radio access network (RAN) operated by the wireless communication service provider with which the user of the UE has a wireless communication service subscription), the UE may not receive the same quality of service it would receive if it were served by the home network. For example, the UE may be restricted to a medium data rate or a low data rate when roaming. For example, the UE may not enjoy premium services the subscriber has contracted for with the service provider of the home network. Additionally, the home network operator incurs roaming charges assessed by the roaming network operators when the UE is roaming in their network. Thus, it is desirable that the UE promptly reattach to the home network as soon as this is possible. According to current practice, however, the UE may not check for home network availability for 6 minutes after the device has entered an idle mode of operation (e.g., no call is active).

The present disclosure teaches a quality of experience (QoE) application that executes on a server computer. The QoE application receives updates of location of a user equipment (UE) from a QoE applet that executes on a subscriber identity module (SIM) of the UE. When the UE is in a roaming mode of operation, the QoE application on the server periodically uses the current location of the UE, as reported by the QoE applet, as an input to a function or look-up table maintained in the server to determine if the UE should attempt to reconnect to a home network of the UE. When the QoE application determines that a rehome attempt is to be made, the QoE application on the server sends a message to the QoE applet on the UE to prompt the UE to rescan available cell sites, for example scanning one or more cell site frequencies. In this case, the QoE applet sends a refresh request to a processor of the UE. In an embodiment, the QoE application on the server sends a short message service (SMS) message to an SMS center (SMSC), and the SMSC sends the message to the QoE applet on the SIM.

The processor of the UE responds to the refresh request by initiating a scan of cell site frequencies. If a cell site of the home network is available, the processor of the UE can cause a radio transceiver of the UE to detach from the roaming cell site and attach to the home network cell site. If a cell site of a roaming network that is preferred to the roaming network of the current serving cell site is available, the processor of the UE can cause the radio transceiver of the UE to detach from the roaming cell site and attach to the preferred roaming network. Note that these transitions can occur relatively quickly and are not restricted to waiting six minutes after the UE enters an idle mode of operation.

In an embodiment, the QoE applet on the SIM reports location of the UE periodically to the QoE server. The QoE applet can also transmit information about the result of rescan attempts of the UE. The QoE application on the server can store the result of rescan attempts by the UE and train an algorithm for deciding at what locations the UE will rehome (or, alternatively, transition to a more preferred network to a given roaming network). The QoE application on the server can benefit from the learning supported by training the algorithm based on rescan results reported by the QoE applet on the SIM. Additionally, it is understood that the QoE application will perform the function described above for a large number of UEs, and the algorithm for deciding at what locations to prompt a UE to rescan can be trained on a large set of data gathered from this large number of UEs.

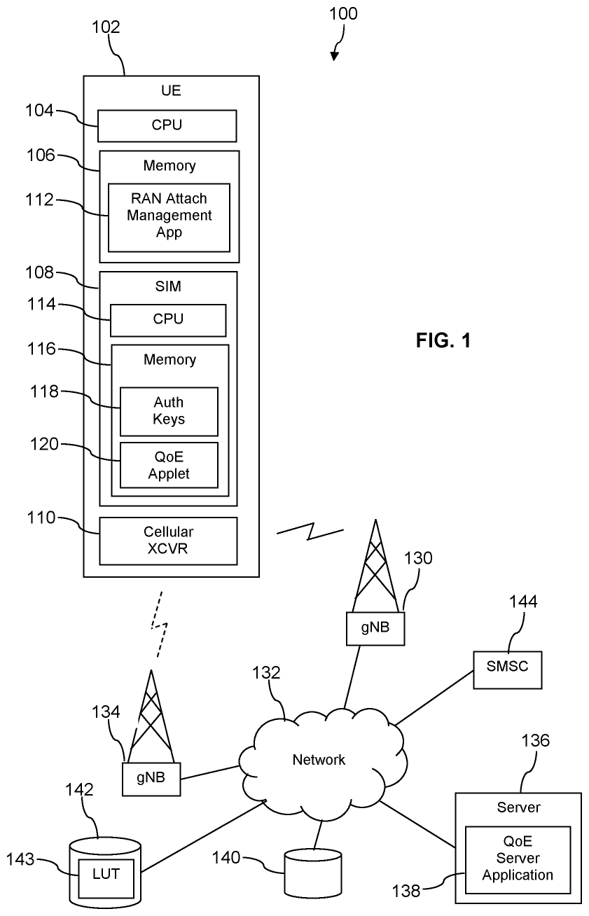

Turning now to FIG. 1, a system 100 is described. In an embodiment, system 100 comprises a user equipment (UE) 102 that comprises a main processor 104, a memory 106, a subscriber identity module (SIM) 108, and a cellular radio transceiver 110. The UE 102 may be referred to in some contexts as a wireless communication device. The UE 102 may be a smart phone, a mobile phone, a wearable computer, a headset computer, a laptop computer, a tablet computer, or a notebook computer.

The memory 106 may comprise a non-transitory memory portion and a transitory memory portion. The non-transitory portion of the memory 106 stores a radio access network (RAN) attachment management application 112. The SIM 108 comprises a SIM processor 114 and a SIM memory 116. The SIM memory 116 may comprise a non-transitory memory portion and a transitory memory portion. The non-transitory memory portion of the SIM memory 116 stores one or more authentication keys 118 and a quality of experience (QoE) applet 120. The authentication keys 118 may be used, directly or indirectly, by the cellular radio transceiver 110 to authenticate with a first cell site 130. The SIM 108 may provide one of the authentication keys 118 to the cellular radio transceiver 110 or to an application executing on the main processor 104. Alternatively, the SIM 108 may generate a derived authentication key based on the authentication keys 118 and provide the derived authentication key to the cellular radio transceiver 110 or to the application executing on the main processor 104 for use in authenticating with the first cell site 130. In an embodiment, the SIM 108 is a removable SIM that can be removed by a user and replaced by a user, for example to change service providers. In an embodiment, the SIM 108 is an embedded SIM, for example a SIM that is connected to a motherboard of the UE 102.

While a single UE 102 is shown in FIG. 1, it will be appreciated that the system 100 is expected to support hundreds of thousands, millions, or tens of millions of UEs. While two cell sites 130, 134 are shown in FIG. 1, it will be appreciated that the system 100 is expected to comprise tens of thousands of cell sites or hundreds of thousands of cell sites. While the cell sites 130, 134 are shown separately, it is understood that these cell sites may be considered to be part of the network 132.

The first cell site 130 may be operated by a first network operator that is different from the wireless communication service provider that a user of the UE 102 has wireless communication service subscription with. Said in other words, the first cell site 130 may be operated by a roaming network operator (from the perspective of the home network service provider). The first cell site 130 can provide a wireless communication link to the UE 102 according to one or more of a 5G, a long-term evolution (LTE), a code division multiple access (CDMA), or a global system for mobile communications (GSM) telecommunication protocol. The first cell site 130 can provide connectivity to a network 132 to the UE 102, whereby the UE 102 can complete voice calls to other UEs and can complete data calls, such as downloading content from content servers or completing transactions with application servers. The network 132 may be one or more private networks, one or more public networks, or a combination thereof.

A second cell site 134 may be operated by the wireless communication service provider that provides subscription service to the UE 102. Said in other words, the second cell site 134 may be associated with the home network of the UE 102. In some circumstances, the received signal strength of the second cell site 134 may be adequate to support a wireless communication link between the cellular radio transceiver 110 and the second cell site 134, while the cellular radio transceiver 110 is attached to the first cell site 130 of the roaming network. In this circumstance it is desirable that the UE 102 detach from the first cell site 130 and attach to the second cell site 134, as discussed above.

The QoE applet 120 captures various information about the communication behavior of the UE 102 and transmits this information back to a server computer 136 and/or to a first data store 140. This information can include an indication of the location of the UE 102. The indication of the location of the UE 102 may be a latitude and longitude of the UE 102. The indication of the location of the UE 102 may be an indication of a geographical location, such as a geohash value. The indication of the location of the UE 102 may be an identity of a cell site the UE 102 is attached to, for example a cell global identifier (CGI), where the identity of the cell site is a kind of proxy for the geographical location of the UE 102. The CGI may comprise a mobile country code (MCC), a mobile network code (MNC), a location area code (LAC), and/or a cell identity. This information can include information about results of cell site frequency scans, for example information on when the scans result in dropping attachment to one radio access network and attaching to a different radio access network. This information can be stored in the first data store 140 and analyzed by a QoE server application 138 that executes on the server computer 136.

Based on the information provided periodically by the QoE applet 120, the QoE application 138 can determine when the UE 102 is operating in a roaming mode (e.g., receiving a wireless link from the first cell site 130) or is operating in the home network (e.g., receiving a wireless link from the second cell site 134). When the UE 102 is roaming, the QoE application 138 can use the indication of the current location of the UE 102 as an index into a look-up table 143 or other data structure stored in a second data store 142 that maps a location to a network that is preferred for the UE 102 to connect to. For example, these preferred networks may be the home network of the subscriber associated with the UE 102 or a roaming network that is preferred to the roaming network the UE 102 is attached to. In some contexts, the second data store 142 and/or the look-up table 143 may be referred to as a geo-location database. In an embodiment, the information stored in the first data store 140 and the look-up table 143 (or other data structure) stored in the second data store 142 are both stored in a single data store. Said in other words, in an embodiment, the first data store 140 and the second data store 142 are combined in a single data store.

In the case that the current location of the UE 102 is associated by the look-up table 143 with a network that is different from the network the UE 102 is currently attached to, the QoE application 138 sends a message to the QoE applet 120 that prompts the QoE applet 120 to send a refresh request to the main processor 104. In an embodiment, the QoE application 138 sends the message as a short message service (SMS) message to a SMS center (SMSC) 144, and the SMSC 144 sends the SMS message to the QoE applet 120. In response to receiving the message from the QoE application 138, the QoE applet 120 sends a refresh message to the main processor 104 and/or to the RAN attachment management application 112. It is understood that the system 100 may comprise any number of servers 136, data stores 140, 142, and SMSCs 144. Additionally, while the server 136, the first data store 140, the second data store 142, and the SMSC 144 are shown separately from the network 132 in FIG. 1 to promote better clarity in the description herein, it is understood that these may be considered to be part of the network 132.

When the RAN attachment management application 112 receives the refresh request, it may initiate a cell site rescan or trigger initiation of a cell site rescan. The cell site rescan scans one or more ranges of cell site frequencies and identifies cell sites proximate to the UE 102 that the cellular radio transceiver 110 is able to detect. In response to the rescan, the RAN attachment management application 112 or another application executing on the main processor 104 may identify a cell site that is different from the first cell site 130 that is associated with a preferred network. For example, the second cell site 134 may be determined to be in the home network of the wireless communication service provider that provides wireless communication subscription service to the UE 102. For example, a cell site may be determined to be in a roaming network that is preferred to the roaming network that operates the first cell site 130. In this case the RAN attachment management application 112 may cause the cellular radio transceiver 110 to detach from the current cell site (e.g., cell site 130) and attach to the preferred cell site (e.g., cell site 134).

In this way, the QoE application 138 may cause the UE 102 to rehome to the home network in less than three minutes after the UE re-enters the wireless coverage of the home network. The QoE application 138 may cause the UE 102 to rehome to the home network in less than four minutes after the UE 102 re-enters the wireless coverage of the home network. The QoE application 138 may cause the UE 102 to rehome to the home network in less than five minutes after the UE 102 re-enters the wireless coverage of the home network. The QoE application 138 may cause the UE 102 to rehome to the home network in less than six minutes after the UE 102 re-enters the wireless coverage of the home network. The QoE application 138 may cause the UE 102 to rehome to the home network in less than two minutes after the UE 102 re-enters the wireless coverage of the home network. The QoE application 138 may cause the UE 102 to attach to a preferred network that is different from the roaming network in less than two minutes after the UE 102 enters the wireless coverage of the preferred network. The QoE application 138 may cause the UE 102 to attach to a preferred network that is different from the roaming network in less than three minutes after the UE 102 enters the wireless coverage of the preferred network. The QoE application 138 may cause the UE 102 to attach to a preferred network that is different from the roaming network in less than four minutes after the UE 102 enters the wireless coverage of the preferred network. The QoE application 138 may cause the UE 102 to attach to a preferred network that is different from the roaming network in less than five minutes after the UE 102 enters the wireless coverage of the preferred network. The QoE application 138 may cause the UE 102 to attach to a preferred network that is different from the roaming network in less than six minutes after the UE 102 enters the wireless coverage of the preferred network.

It will be appreciated that the result of the QoE application 138 prompting the QoE applet 120 to request a refresh and hence trigger a rescan will not always have the desired result of returning the UE 102 more quickly to the home network and to stop roaming. In some instances, a network preferred to the current roaming network is not identified during the frequency rescan or does not qualify because of insufficient received signal strength associated with the cell site of the preferred network. Said in other words, the algorithm executed by the QoE application 138 is not expected to be perfect and to always have the desired result. Notwithstanding, it is expected that the algorithm executed by the QoE application 138 will, more often then not, succeed in causing the UE 102 to migrate to the home network or to a different preferred network than the current roaming network when it sends the message prompting the QoE applet 120 to request a refresh.

Additionally, the QoE application 138 will analyze the history of its sending messages to the UE 102 and to other UEs and the reported results of the associated rescans performed by the UE 102 and by other UEs (e.g., the information stored in the first data store 140). The QoE applet 120 can then train its algorithm based on this analysis of history and improve the likelihood that its messaging the QoE applet 120 to request a refresh will have the desired result. Retraining the algorithm may result in updating the look-up table 143 or other data structure stored in the second data store 142.

The QoE application 138 may perform such retraining of its algorithm on a periodic basis such as daily, weekly, every other week, once per month, once per quarter, twice per year, or some other periodic interval. It will be appreciated that this retraining of the algorithm will have the effect of automatically updating the performance of the QoE application 138 (e.g., by updating the look-up table 143 or other data structure used by the QoE application 138) as the network 132 changes over time, for example as new cell sites are added by the home network and/or by roaming networks and as old cell sites are decommissioned by the home network and/or by roaming networks. Additionally, the retraining of the algorithm will have the effect of automatically updating the performance of the QoE application 138 as cell sites change their performance (e.g., a cell site that is neither recently put into service and not decommissioned) over time, for example as equipment degrades over time or as a radio environment of cell sites change due to foliage changes or seasonal precipitation patterns change.

The look-up table 143 or other data structure may be implemented in various ways. In an embodiment, every CGI of every cell site in the United States may be listed in the look-up table 143 as a primary key or index (e.g., a separate row in the look-up table 143 for each different CGI). In this case, every CGI would be mapped by the look-up table 143 to a preferred network that associates to the location associated with the given CGI (where the given CGI is a proxy for a location). Alternatively, every CGI would be mapped by the look-up table 143 to a preferred CGI that is located proximate to the given CGI. It will be appreciated that such a look-up table 143 might be very large and might be difficult to maintain. In another embodiment, a more efficient structuring of the look-up table 143 or other data structure may be constructed based on organization used in assigning CGIs to cell sites. For example, a contiguous range of CGIs may be associated with a general area, and this general area may be associated with a particular CGI (for example the first CGI in the range) and this particular CGI could index into a row of the look-up table that identifies a preferred network or range of CGIs for that general area.

When the QoE application 138 knows the UE 102 is roaming, based on the information sent by the UE 102 to the QoE application 138 and/or to the first data store 140, the QoE application 138 can use the CGI of the cell site the UE 102 indicates that it is currently attached to as an index into the look-up table 143. If the CGI the UE 102 is attached to is the CGI indexed to in the look-up table 143 or if the CGI the UE 102 is attached to is associated with the network indexed by the given CGI, the QoE application 138 does not send a message to the UE 102. On the other hand, if the CGI maps to a different CGI or to a different network than the current CGI or the current network, the QoE application 138 sends a message to the QoE applet 120 prompting the QoE applet 120 to request a refresh from the RAN attachment management application 112.

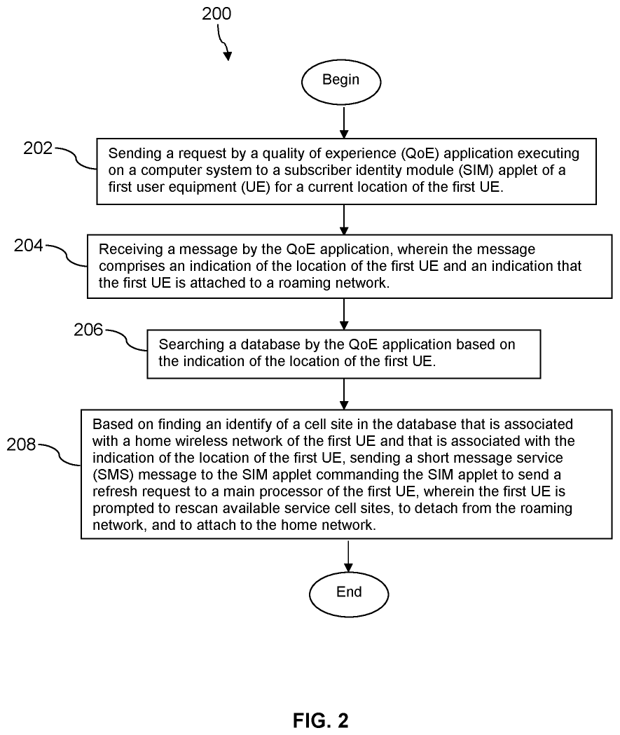

Turning now to FIG. 2, a method 200 is described. In an embodiment, the method 200 is a method of managing roaming activity of a user equipment (UE). At block 202, the method 200 comprises sending a request by a quality of experience (QoE) application executing on a computer system to a subscriber identity module (SIM) applet of a user equipment (UE) for a current location of the UE. In an embodiment, the QoE application sends the request to know where the wireless communication device is located more often than once every six minutes—for example about once every 350 seconds, about once every 330 seconds, about once every 315 seconds, about once every 300 seconds, about once every 270 seconds, about once every 240 seconds, about once every 210 seconds, about once every 180 seconds, about once every 150 seconds, about once every 120 seconds, about once every 90 seconds, about once every 60 seconds, about once every 30 seconds, or some other time period. In an embodiment, the QoE application sends the request to know where the wireless communication device is located periodically with a period of less than six minutes. In an embodiment, the QoE application sends the request to know where the wireless communication device is located periodically with a period of less than five minutes. In an embodiment, the QoE application sends the request to know where the wireless communication device is located periodically with a period of less than four minutes. In an embodiment, the QoE application sends the request to know where the wireless communication device is located periodically with a period of less than three minutes. In an embodiment, the QoE application sends the request to know where the wireless communication device is located periodically with a period of less than two minutes. In an embodiment, the UE is one of a smart phone, a mobile phone, a wearable computer, a headset computer, a laptop computer, a tablet computer, or a notebook computer.

At block 204, the method 200 comprises receiving a message by the QoE application, wherein the message comprises an indication of the location of the UE and an indication that the UE is attached to a roaming network. In an embodiment, the indication of the location of the UE is a cell global identifier (CGI) of a cell site. In an embodiment, the indication of the current location of the UE is a latitude and longitude of the UE. In an embodiment, the indication of the current location of the UE is a geohash value. At block 206, the method 200 comprises searching a database by the QoE application based on the indication of the location of the UE.

At block 208, the method 200 comprises, based on finding a preferred network in the database that is associated with the indication of the location of the UE, sending a short message service (SMS) message to the SIM applet commanding the SIM applet to send a refresh request to a main processor of the UE, wherein the UE is prompted to rescan available cell site frequencies, to detach from the roaming network, and to attach to the preferred network. In an embodiment, the cell site frequencies are associated with any of a 5G, a long-term evolution (LTE), a code division multiple access (CDMA), or a global system for mobile communications (GSM) telecommunication protocol. In an embodiment, the QoE application sends the SMS message to the SIM applet via a SMS center (SMSC).

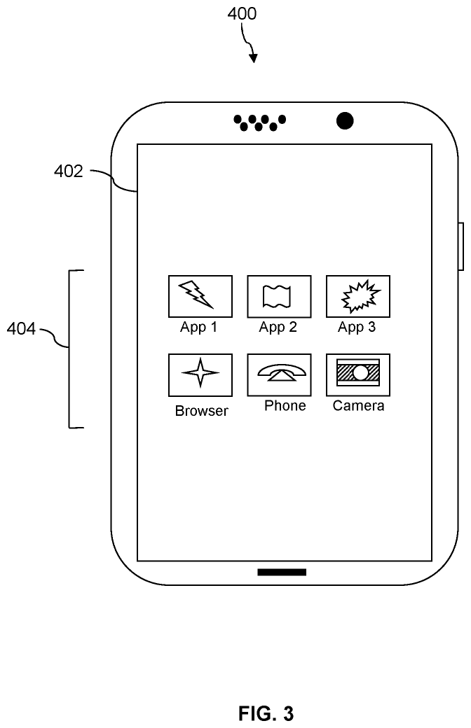

FIG. 3 depicts the user equipment (UE) 400, which is operable for implementing aspects of the present disclosure, but the present disclosure should not be limited to these implementations. Though illustrated as a mobile phone, the UE 400 may take various forms including a wireless handset, a pager, a personal digital assistant (PDA), a gaming device, or a media player. The UE 400 includes a touchscreen display 402 having a touch-sensitive surface for input by a user. A small number of application icons 404 are illustrated within the touch screen display 402. It is understood that in different embodiments, any number of application icons 404 may be presented in the touch screen display 402. In some embodiments of the UE 400, a user may be able to download and install additional applications on the UE 400, and an icon associated with such downloaded and installed applications may be added to the touch screen display 402 or to an alternative screen. The UE 400 may have other components such as electro-mechanical switches, speakers, camera lenses, microphones, input and/or output connectors, and other components as are well known in the art. The UE 400 may present options for the user to select, controls for the user to actuate, and/or cursors or other indicators for the user to direct. The UE 400 may further accept data entry from the user, including numbers to dial or various parameter values for configuring the operation of the handset. The UE 400 may further execute one or more software or firmware applications in response to user commands. These applications may configure the UE 400 to perform various customized functions in response to user interaction. Additionally, the UE 400 may be programmed and/or configured over-the-air, for example from a wireless base station, a wireless access point, or a peer UE 400. The UE 400 may execute a web browser application which enables the touch screen display 402 to show a web page. The web page may be obtained via wireless communications with a base transceiver station, a wireless network access node, a peer UE 400 or any other wireless communication network or system.

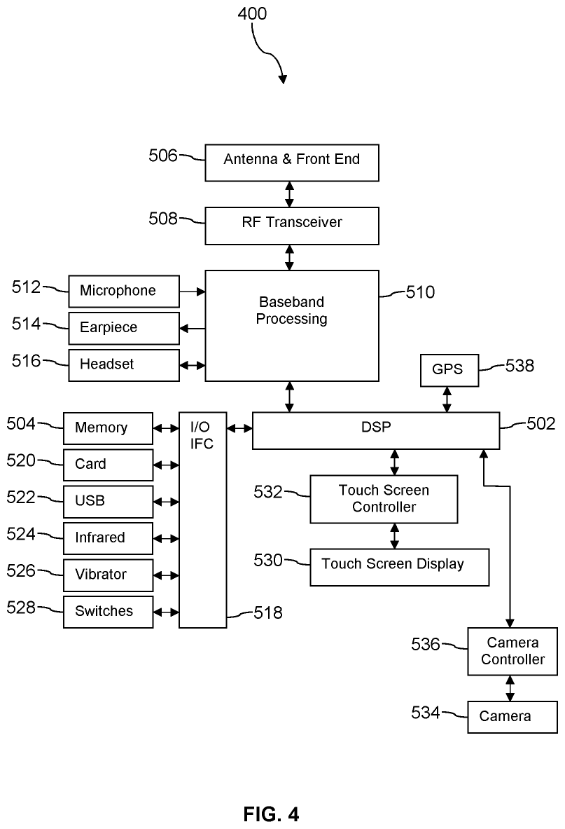

FIG. 4 shows a block diagram of the UE 400. While a variety of known components of handsets are depicted, in an embodiment a subset of the listed components and/or additional components not listed may be included in the UE 400. The UE 400 includes a digital signal processor (DSP) 502 and a memory 504. As shown, the UE 400 may further include one or more antenna and front end unit 506, a one or more radio frequency (RF) transceiver 508, a baseband processing unit 510, a microphone 512, an earpiece speaker 514, a headset port 516, an input/output interface 518, a removable memory card 520, a universal serial bus (USB) port 522, an infrared port 524, a vibrator 526, one or more electro-mechanical switches 528, a touch screen display 530, a touch screen controller 532, a camera 534, a camera controller 536, and a global positioning system (GPS) receiver 538. In an embodiment, the UE 400 may include another kind of display that does not provide a touch sensitive screen. In an embodiment, the UE 400 may include both the touch screen display 530 and additional display component that does not provide a touch sensitive screen. In an embodiment, the DSP 502 may communicate directly with the memory 504 without passing through the input/output interface 518. Additionally, in an embodiment, the UE 400 may comprise other peripheral devices that provide other functionality.

The DSP 502 or some other form of controller or central processing unit operates to control the various components of the UE 400 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The DSP 502 may communicate with a wireless network via the analog baseband processing unit 510. In some embodiments, the communication may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB port 522 and the infrared port 524. The USB port 522 may enable the UE 400 to function as a peripheral device to exchange information with a personal computer or other computer system. The infrared port 524 and other optional ports such as a Bluetooth® interface or an IEEE 802.11 compliant wireless interface may enable the UE 400 to communicate wirelessly with other nearby handsets and/or wireless base stations.

In an embodiment, one or more of the radio transceivers is a cellular radio transceiver. A cellular radio transceiver promotes establishing a wireless communication link with a cell site according to one or more of a 5G, a long-term evolution (LTE), a code division multiple access (CDMA), a global system for mobile communications (GSM) wireless communication protocol. In an embodiment, one of the radio transceivers 508 may comprise a near field communication (NFC) transceiver. The NFC transceiver may be used to complete payment transactions with point-of-sale terminals or other communications exchanges. In an embodiment, each of the different radio transceivers 508 may be coupled to its own separate antenna. In an embodiment, the UE 400 may comprise a radio frequency identify (RFID) reader and/or writer device.

The switches 528 may couple to the DSP 502 via the input/output interface 518 to provide one mechanism for the user to provide input to the UE 400. Alternatively, one or more of the switches 528 may be coupled to a motherboard of the UE 400 and/or to components of the UE 400 via a different path (e.g., not via the input/output interface 518), for example coupled to a power control circuit (power button) of the UE 400. The touch screen display 530 is another input mechanism, which further displays text and/or graphics to the user. The touch screen LCD controller 532 couples the DSP 502 to the touch screen display 530. The GPS receiver 538 is coupled to the DSP 502 to decode global positioning system signals, thereby enabling the UE 400 to determine its position.

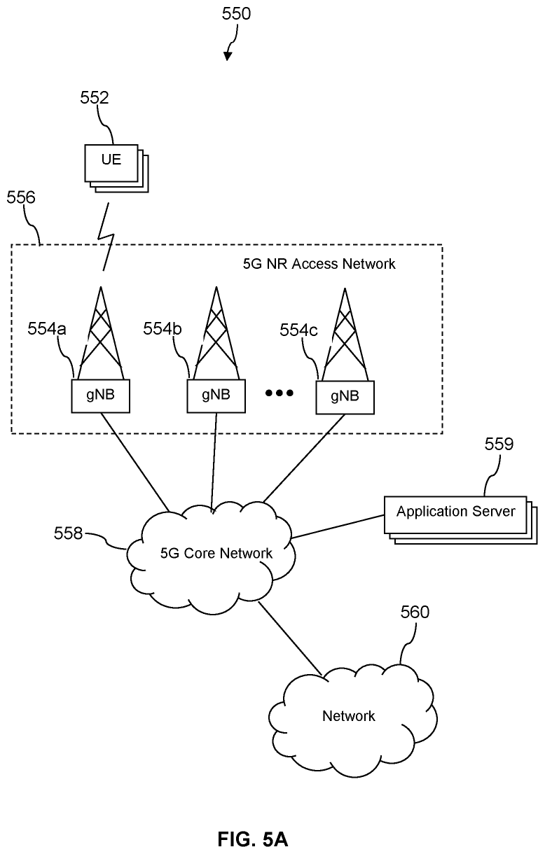

Turning now to FIG. 5A, an exemplary communication system 550 is described. Typically, the communication system 550 includes a number of access nodes 554 that are configured to provide coverage in which UEs 552 such as cell phones, tablet computers, machine-type-communication devices, tracking devices, embedded wireless modules, and/or other wirelessly equipped communication devices (whether or not user operated), can operate. The access nodes 554 may be said to establish an access network 556. The access network 556 may be referred to as a radio access network (RAN) in some contexts. In a 5G technology generation an access node 554 may be referred to as a next Generation Node B (gNB). In 4G technology (e.g., long-term evolution (LTE) technology) an access node 554 may be referred to as an evolved Node B (eNB). In 3G technology (e.g., code division multiple access (CDMA) and global system for mobile communication (GSM)) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as Long-Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data.

Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 5B, further details of the core network 558 are described. In an embodiment, the core network 558 is a 5G core network. 5G core network technology is based on a service-based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 5A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow-based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on the application server 559, discussed above with reference to FIG. 5A, and located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

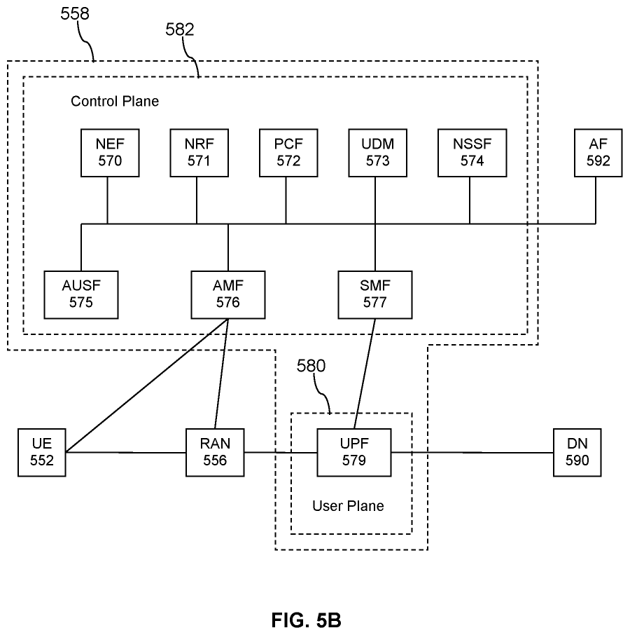

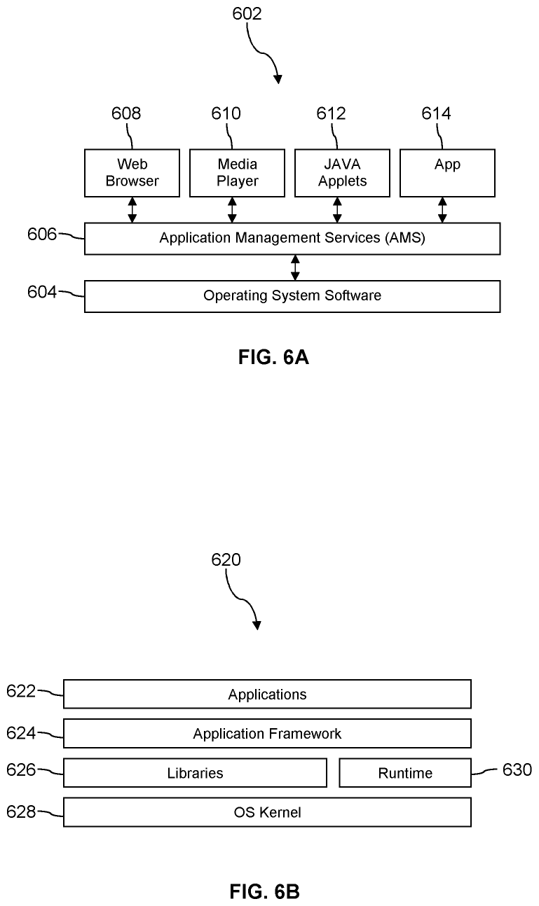

FIG. 6A illustrates a software environment 602 that may be implemented by the DSP 502. The DSP 502 executes operating system software 604 that provides a platform from which the rest of the software operates. The operating system software 604 may provide a variety of drivers for the handset hardware with standardized interfaces that are accessible to application software. The operating system software 604 may be coupled to and interact with application management services (AMS) 606 that transfer control between applications running on the UE 400. Also shown in FIG. 6A are a web browser application 608, a media player application 610, JAVA applets 612, and optionally one or more applications 614. The web browser application 608 may be executed by the UE 400 to browse content and/or the Internet, for example when the UE 400 is coupled to a network via a wireless link. The web browser application 608 may permit a user to enter information into forms and select links to retrieve and view web pages. The media player application 610 may be executed by the UE 400 to play audio or audiovisual media. The JAVA applets 612 may be executed by the UE 400 to provide a variety of functionality including games, utilities, and other functionality.

FIG. 6B illustrates an alternative software environment 620 that may be implemented by the DSP 502. The DSP 502 executes operating system kernel (OS kernel) 628 and an execution runtime 630. The DSP 502 executes applications 622 that may execute in the execution runtime 630 and may rely upon services provided by the application framework 624. Applications 622 and the application framework 624 may rely upon functionality provided via the libraries 626.

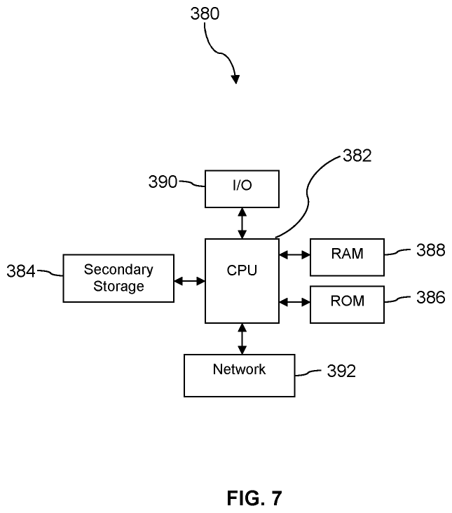

FIG. 7 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of managing roaming activity of a user equipment (UE), comprising:
sending a request by a quality of experience (QoE) application executing on a computer system to a subscriber identity module (SIM) applet of a user equipment (UE) for a current location of the UE more often than once every six minutes;
receiving a message by the QoE application, wherein the message comprises an indication of the location of the UE and an indication that the UE is attached to a roaming network;
searching a database by the QoE application based on the indication of the location of the UE; and
based on finding a preferred network in the database that is associated with the indication of the location of the UE, sending a short message service (SMS) message to the SIM applet commanding the SIM applet to send a refresh request to a main processor of the UE, wherein the UE is prompted to rescan available cell site frequencies, to detach from the roaming network, and to attach to the preferred network.

2. The method of claim 1, wherein the cell site frequencies are associated with any of a 5G, a long-term evolution (LTE), a code division multiple access (CDMA), or a global system for mobile communications (GSM) telecommunication protocol.

3. The method of claim 1, wherein the QoE application sends the SMS message to the SIM applet via a SMS center (SMSC).

4. The method of claim 1, wherein the UE is one of a smart phone, a mobile phone, a wearable computer, a headset computer, a laptop computer, a tablet computer, or a notebook computer.

5. The method of claim 1, wherein the indication of the location of the UE is a cell global identifier (CGI) of a cell site.

6. The method of claim 1, wherein the indication of the current location of the UE is a latitude and longitude of the UE.

7. The method of claim 1, wherein the indication of the current location of the UE is a geohash value.

8. A method of managing roaming activity of a user equipment (UE), comprising:
sending a request by a quality of experience (QoE) application executing on a computer system to a first subscriber identity module (SIM) applet of a first user equipment (UE) for a current location of the first UE, wherein the first UE is subscribed to receive wireless communication service with the home wireless communication service network;
receiving an indication of the location of the first UE by the QoE application from the first SIM applet, wherein the first UE is in a roaming operation mode;
searching a geo-location database by the QoE application using the indication of the location of the first UE, wherein the geo-location database associates geo-locations to a home network or to a preferred network;
based on searching the geo-location database, determining by the QoE application that the home network is located proximate to the indication of the location of the first UE;
sending a request by the QoE application to the first SIM applet to perform a refresh operation, wherein the first UE initiates a scan of cell site frequencies, detects a first cell site associated with the home network, and attaches wirelessly to the first cell site;
receiving a feedback message by the QoE application from the first SIM applet reporting the successful rehoming of the first UE to the home network via the first cell site and at the indicated location of the first UE; and
updating the geo-location database by the QoE application with the information about the successful rehoming of the first UE to the home network, wherein the geo-location database is progressively adapted based on feedback information received from the first UE.

9. The method of claim 8, wherein the indication of the current location of the first UE is a cell global identifier (CGI) of a cell site.

10. The method of claim 8, wherein the indication of the current location of the first UE is a latitude and longitude of the first UE.

11. The method of claim 8, wherein the indication of the current location of the first UE is a geohash value.

12. The method of claim 8, further comprising:
sending a request by the QoE application to a second SIM applet of a second UE for a current location of the second UE, wherein the second UE is subscribed to receive wireless communication service with the home wireless communication service network
receiving an indication of the location of a second UE by the QoE application from the second SIM applet, wherein the second UE is in a roaming operation mode,
searching the geo-location database by the QoE application using the indication of the location of the second UE,
based on searching the geo-location database, determining by the QoE application that a preferred network is located proximate to the indication of the location of the second UE, wherein the preferred network is different from a roaming network the second UE is attached to, and
sending a request by the QoE application to the second SIM applet to perform a refresh operation, wherein the second UE initiates a scan of cell site frequencies, detects a second cell site associated with the preferred network, detaches wirelessly from the roaming network, and attaches wirelessly to the second cell site.

13. The method of claim 8, wherein the QoE application sends the message to the first UE as a short message service (SMS) message.

14. The method of claim 8, wherein the UE is one of a smart phone, a mobile phone, a wearable computer, a headset computer, a laptop computer, a tablet computer, or a notebook computer.

15. A quality of experience server computer associated with a home wireless communication service network, comprising:
a processor;
a non-transitory memory, wherein the non-transitory memory stores a geo-location database that associates geo-locations to a home network or to a preferred network; and
a quality of experience application stored in the non-transitory memory that, when executed by the processor
receives an indication of a location of a user equipment (UE), wherein the first UE is subscribed to receive wireless communication service with the home wireless communication service network and the UE is in a roaming operation mode,
searches the geo-location database using the indication of the location of the UE,
based on searching the geo-location database, determines that the home network or a preferred network is located proximate to the indication of the location of the UE, and
sends a request to the UE to perform a refresh operation, wherein the UE initiates a scan of cell site frequencies, detects a cell site associated with the home network or the preferred network, and attaches wirelessly to the cell site.

16. The quality of experience server computer of claim 15, wherein the quality of experience application causes the UE to rehome in less than three minutes after the UE re-enters wireless coverage of the home network.

17. The quality of experience server computer of claim 15, wherein the quality of experience application sends the request as a short message service (SMS) message to the UE.

18. The quality of experience server computer of claim 15, wherein the quality of experience application sends the request to a subscriber identity module (SIM) applet of the UE.

19. The quality of experience server computer of claim 18, wherein the SIM applet sends a refresh message to a main processor of the UE.

20. The quality of experience server computer of claim 15, wherein the UE is one of a smart phone, a mobile phone, a wearable computer, a headset computer, a laptop computer, a tablet computer, or a notebook computer.
